(19) United States
(12) Patent Application Publication
(10) Pub. No.: US 2010/0001217 A1
(43) Pub. Date: Jan. 7, 2010

(54) DAMPING FORCE VARIABLE VALVE OF SHOCK ABSORBER

(75) Inventors: Young Whan Jee, Gyeonggi-do (KR); Kyu Shik Park, Seoul (KR)

Correspondence Address: SEED INTELLECTUAL PROPERTY LAW GROUP PLLC, 701 FIFTH AVE, SUITE 5400, SEATTLE, WA, 98104, US

(73) Assignee: MANDO CORPORATION, Gyeonggi-do (KR)

(21) Appl. No.: 12/497,026

(22) Filed: Jul. 2, 2009

(30) Foreign Application Priority Data
Jul. 3, 2008 (KR) 10-2008-0064536

(51) Int. Cl. F16K 31/06

(52) U.S. Cl. 251/129.15

(57) ABSTRACT

A damping force variable valve includes a retainer including a spool rod part having a hollow portion formed at a central portion thereof to allow a spool to be inserted in the hollow portion, a solenoid part coupled to a lower side of the retainer and having a bobbin provided therein, the bobbin having a coil wound therearound for allowing a pressurizing rod in contact with the spool to move when voltage is applied, and a connector for connecting to a power supply part formed integrally with the bobbin.

### BACKGROUND

1. Technical Field

The present disclosure relates to a damping force variable valve, and more particularly, to a damping force variable valve of a shock absorber, wherein a connector is provided on a power supply part of a solenoid part to make an assembling process easy and the automatization thereof possible.

2. Description of the Related Art

In general, a shock absorbing device is provided in a vehicle to absorb vibrations or shocks transmitted from a road surface to an axle of the vehicle when the vehicle is driven and thus to improve a ride comfort. As one of the shock absorbing devices, a shock absorber has been employed in a vehicle.

This shock absorber lowers damping force when a vehicle is driven under a normal condition to absorb vibrations caused by irregularities of a road surface and to enhance the ride comfort. Also, when the vehicle is turned, accelerated, decelerated, and/or driven at high-speed, this shock absorber increases damping force to restrain a posture of a vehicle body from being changed, whereby the handling stability of the vehicle can be enhanced.

In recent, in the meantime, a damping force variable valve capable of adjusting appropriately a characteristic of damping force is provided on one side of the shock absorber, so that the shock absorber has been developed into a damping force variable type shock absorber which can adjust a characteristic of damping force appropriately according to a condition of a road surface and a driving status of a vehicle in order to enhance the ride comfort or handling stability of the vehicle.

To this end, a damping force variable shock absorber has a damping force variable valve for varying damping force provided at one side of a base shell.

FIG. 1 is a sectional view of a damping force variable valve according to a prior art, wherein a damping force variable valve 10 is configured such that a spool 30 operates in a poppet valve manner with respect to a spool rod 20 to control fluid communication. As shown in the figure, the conventional damping force variable valve 10 comprises a solenoid part 40, the spool rod 20, the spool 30, a lower retainer 22, a main disk 26 and an upper retainer 24.

The spool rod 20 is a hollow cylindrical rod and provided at a leading end of a driving block 46 of the solenoid part 40. A plug 21 is installed at an upper end of the spool rod 20, and a coil spring 21a is embedded between the plug 21 and the spool 30 to bring the spool 30 into close contact with a pressurizing rod 44. In addition, a plurality of connecting ports 20a, 20b and 20c through which fluid flows are formed in the spool rod 20 to pass therethrough.

The lower retainer 22 is provided on an outer circumferential surface of the spool rod 20. An inflow passage 22a, a discharge passage 22b and a detour passage are formed in the lower retainer 22 to pass therethrough.

Also, the main disk 26 is disposed such that it covers the inflow passage 22a at a rear side of the lower retainer 22, so that working fluid passing through the inflow passage 22a directly strikes the main disk to thereby generate damping force.

In addition, the upper retainer 24 is provided at an upper side of the lower retainer 22 to form a guide flow passage through which fluid is guided from a high pressure chamber of the shock absorber to an interior of the lower retainer 22. A nut 28 for securing the lower retainer 22 is installed on an outer circumferential surface of an upper end of the spool rod 20.

The solenoid part 40 has an upper end fixedly installed to a lower end of a valve housing 12 to be coupled an outside of the shock absorber. The solenoid part 40 includes a bobbin 42 and the pressurizing rod 44 which vertically moves in response to a variation of current supplied to a coil wound around the bobbin 42 provided in the driving block 46. The solenoid part 40 so configured is finished by a cover part 48 coupled to a lower side thereof.

In the meantime, the solenoid part 40 has a power supply part 50 protruding on a side surface thereof for supplying electric power to the coil, and the power supply part 50 has an electrical cable 52 extending therefrom.

In the conventional damping force variable valve 10, however, due to the power supply part 50 provided on a side surface of the solenoid part and the electrical cable 52 connected to the power supply part 50, these parts may interfere with each other in an assembling process, which makes it impossible to automate the assembling process. In addition, the bobbin 42 and the power supply part 50 of the conventional solenoid part 40 are separated from each other and they are assembled using coupling means such as screws and the like. Accordingly, a process of assembling these parts is complicated and performed manually, resulting in a strong likelihood of generation of quality dispersion of the products.

### BRIEF SUMMARY

In one embodiment, a connector is formed integrally with a bobbin of a solenoid part and is formed in a direction opposite to a coupling direction of the solenoid part, thereby preventing interference in an assembling process and making the automatization thereof possible.

A damping force variable valve according to one embodiment includes a cylinder and a reservoir chamber in fluid communication with the cylinder and being installed to a shock absorber formed with a high pressure part connected to a rebound chamber of the cylinder and a low pressure part connected to the reservoir chamber. In one aspect, the damping force variable valve includes a main body connected at a central part thereof to the high pressure part, the main body having an outer diameter increased outwards, a retainer formed integrally with the main body to extend from a central portion thereof, the retainer including a spool rod part having a hollow portion formed at a central portion thereof to allow a spool to be inserted in the hollow portion; and a solenoid part coupled to a lower side of the retainer and having a bobbin provided therein, the bobbin having a coil wound therearound for allowing a pressurizing rod in contact with the spool to move when voltage is applied, a connector for connecting to a power supply part being formed integrally with the bobbin.

In one aspect, the connector may be formed adjacent or under the solenoid part. In one aspect, the solenoid part may include a cover part coupled to a lower side of the solenoid part to protect an interior thereof and having an opening through which the connector passes, and an expansion part formed to extend on an outer circumference of the cover to cover the retainer, wherein an upper end of the expansion part is bent to secure the retainer.

### BRIEF DESCRIPTION OF THE SEVERAL VIEWS OF THE DRAWINGS

FIG. 1 is a sectional view of a damping force variable valve according to a prior art; and

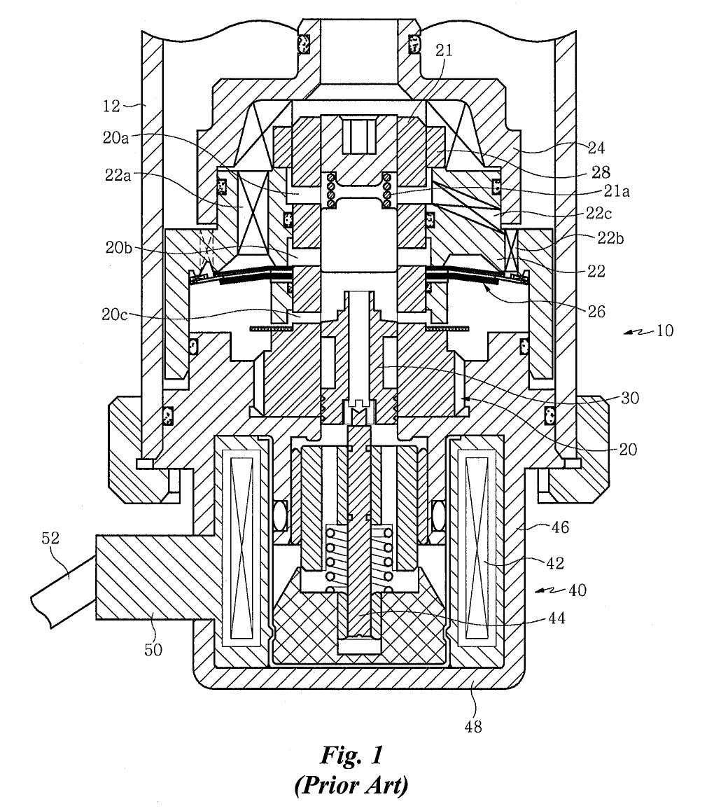

FIG. 2 is a sectional view of a damping force variable valve according to one embodiment.

### DETAILED DESCRIPTION

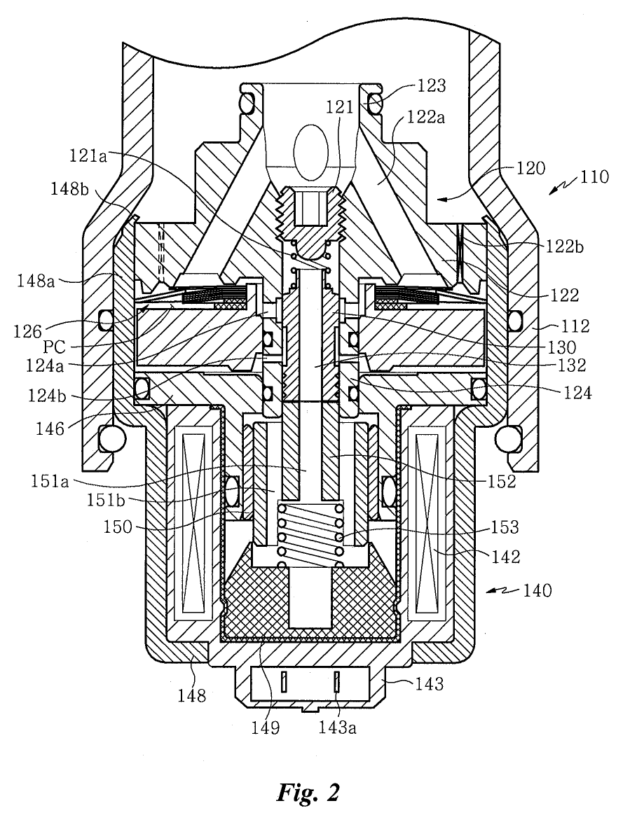

FIG. 2 is a sectional view of a damping force variable valve 10 according to one embodiment.

The damping force variable valve 110 includes a cylinder and a reservoir chamber communicating with the cylinder and can be installed in a shock absorber which is formed with a high pressure part connected to a rebound chamber of the cylinder and a low pressure part connected to the reservoir chamber.

Such a damping force variable valve 110 includes a retainer 120 installed in a valve housing 112 and a main disk 126, and a solenoid part 140 coupled to a lower side of the valve housing 112.

The retainer 120 includes a main body 122 and a spool rod part 124 which in one aspect can be formed integrally with the main body 122.

The main body 122 is connected to a high pressure part at a central portion thereof and is formed to have a portion with a larger outer diameter. To this end, in the retainer 120, a connecting port 123 is configured to be coupled to the high pressure part of the shock absorber and formed toward an upper end of the main body 122.

An inflow passage 122a in fluid communication with the connecting port 123 is formed in the main body 122. In one embodiment, the inflow passage 122a can extend at an angle with respect to a longitudinal axis of the main body 122 to conform to a shape of the main body 122, so that working fluid that has passed through the inflow passage 122a is discharged to a low side of the retainer 120.

The spool rod part 124 is positioned at least in part toward a lower central portion of the main body 122, and a hollow portion into which a spool 130 is inserted is formed at a central portion of the spool rod part 124. In one embodiment, the spool rod part 124 is formed with at least an upper connecting port 124a and a lower connecting port 124b through which fluid can pass. The upper connecting port 124a is in fluid communication with inflow passage 122a to route working fluid introduced from the inflow passage 122a, to an inside of the spool rod part 124. The working fluid is supplied to a back-pressure chamber PC through the connecting port 124b, and pressure for opening/closing the main disk 126 is controlled by the working fluid introduced into the back pressure chamber PC.

Meanwhile, in a state where the spool 130 is inserted in the hollow portion, a spring 121a for elastically supporting the spool 130 is mounted to the spool rod part 124, and a plug 121 is coupled to an upper side thereof.

The main disk 126 is disposed to cover the inflow passage 122a toward a side of the retainer 120, such as a rear side thereof, so that the main disk 126 is directly struck by the working fluid passing through the inflow passage 122a to thereby generate a damping force. The main disk 126 stands against the working fluid flowing in the inflow passage 122a and then is leaned backward to allow the working fluid to flow toward a discharging passage 122b.

In addition, an internal slit can be formed on an internal side of the main disk 126 to allow a portion of the working fluid passing through the inflow passage 122a to flow in a direction other than the discharge passage 122b. In one embodiment, the internal slit fluidly communicates with the connecting port of the spool 130. In one embodiment, an external slit can be formed on an external side of the main disk 126. This external slit fluidly communicates with the discharge passage 122b. The discharge passage 122b is formed on the retainer 120 to allow fluid, which leans the main disk 126 backward according to the pressure in the back pressure chamber PC and is then supplied, to be discharged to the low pressure part of the shock absorber.

The solenoid part 140 includes an upper end detachably coupled to a lower end of the valve housing 112 which is configured to be coupled to the shock absorber. Also, the solenoid part 140 includes a bobbin 142, around which a coil is wound to generate magnetic force according to a change in current, and a spool pressurizing part 150, which is installed to be movable in response to a change in the current supplied to the coil wound around the bobbin 142.

A connector 143 having connecting pins 143a for connecting to a power supply part may be formed integrally with the bobbin 142. In one embodiment, the connector 143 may be formed in a direction opposite to a direction in which the solenoid part 140 and the retainer 120 are coupled. For example, in one embodiment, the connector 143 can be coupled such that the connector pins 143a extend substantially perpendicular to a longitudinal axis of the solenoid part 140. In one embodiment, the connector 143 is formed adjacent or below the bobbin 142. After assembly, the connector 43 may be inserted into and electrically connected to a socket part provided at an end of an extension cable (not shown).

Also, in one embodiment, a driving block 146 can be provided toward an upper side of the solenoid part 140 and configured to guide the spool pressurizing part 150 and finish the upper side of the solenoid part 140. Further, a cover part 148 is coupled toward at least a lower end of the solenoid part 140 to protect an interior thereof. In one embodiment, an opening, through which the connector 143 passes, is formed toward a center portion of the cover part 148. Also, an outer circumferential surface of the cover part 148 extends upward to define an expansion part 148a. This expansion part 148a extends to cover the retainer 120. In a state where the retainer 120 is inserted, an upper end 148b of the expansion part 148a can be bent to further secure the retainer 120. For example, the upper end 148b of the expansion part 148a can be bent by a cocking or curling process to facilitate preventing the retainer 20 from escaping.

In one embodiment, the spool pressurizing part 150 can include a cylindrical shape. In one embodiment, an extension 152 can be formed at a central portion of the spool pressurizing part 150 and be in contact with the spool 130. The extension 152 can be partially inserted into the hollow portion of the spool rod part 124. The extension 152 is moved together with the spool pressurizing part 150 by current applied to the solenoid part 140, and thus, the spool 130 is moved in response to the movement of the spool pressurizing part 152.

The spool 130 has a hollow flow passage 132 passing through a central portion thereof. Accordingly, the working fluid flows by a pressure difference generated when the spool 130 is moved, thereby counterbalancing the pressure difference.

In addition, the spool pressurizing part 150 is formed with a first flow passage 151a, which passes through a central portion of the extension 152 and fluidly communicates with the hollow flow passage 132, and a second flow passage 151b formed on an outer circumference of the extension 152. Therefore, the working fluid passing through the spool 130 is discharged to the first and second flow passages 151a and 151b of the spool pressurizing part 150 and a space between the spool pressurizing part 150 and a guide part 149, and counterbalances a difference in back pressure caused by the movement of the spool pressurizing part 150. Accordingly, when the spool pressurizing part 150 is moved, vibrations are substantially prevented and the spool 130 which is in contact therewith can move without vibration.

In one embodiment, the guide part 149 can be provided inside of the cover part 148 to support a spring 153 provided between the cover part 148 and the spool pressurizing part 150, and guide the movement of the spool pressurizing part 150.

In a damping force variable valve according to embodiments of the present invention, a power supply part which causes interference when the solenoid part and the retainer are assembled is improved by a connection manner using a connector, whereby it is possible to automate a process of assembling the solenoid part and the retainer to significantly reduce manufacturing time and cost, and improve quality of the assembly. In one embodiment, in a state where the retainer is coupled to the solenoid part, a bending process can be performed to maintain the coupling of the two members. Accordingly, there is no need to employ an additional coupling means, so that it is possible to reduce the number of parts and to simplify an assembling process. The present invention as described above has an advantage in that a conventional power supply part is improved to enable an assembling process to be automated, so that the productivity can be enhanced and a quality dispersion of products caused in an assembling process can be reduced.

Although the damping force variable valve according to example embodiments of the present invention so configured has been described with reference to the accompanying drawing, the present invention does not limited to the aforementioned embodiment and the accompanying drawings. It will be apparent that those skilled in the art can make various modifications and changes thereto within the scope of the invention defined by the claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A damping force variable valve comprising:
a retainer having a main body;
a spool rod having a hollow portion formed toward a central portion thereof;
a spool positioned in the hollow portion;
a solenoid coupled to a lower side of the retainer and having a bobbin and a pressurizing rod in contact with the spool, the bobbin having a coil wound therearound to facilitate movement of the pressurizing rod in response to electrical power; and
a connector configured to be electrically coupled to a power supply formed integrally with the bobbin.

2. The damping force variable valve as claimed in claim 1 wherein the connector is formed adjacent the bobbin.

3. The damping force variable valve as claimed in claim 1 wherein the solenoid includes a cover coupled to a lower side of the solenoid to protect an interior thereof and having an opening through which the connector passes, an expansion extending from an outer circumference of the cover and coupled to at least a portion of the retainer, wherein an upper end of the expansion is bent to secure the retainer.

4. The damping force variable valve as claimed in claim 1 wherein the main body includes a connecting port configured to be coupled to a high pressure region of a cylinder when assembled.

5. The damping force variable valve as claimed in claim 1 wherein the main body includes an upper region having a first outer diameter and a lower region having a second outer diameter longer than the first outer diameter.
